(19) United States
(12) Patent Application Publication
(10) Pub. No.: US 2026/0086403 A1
(43) Pub. Date: Mar. 26, 2026

(54) ELECTRONIC DEVICE

(71) Applicant: InnoLux Corporation, Miao-Li County (TW)

(72) Inventors: Cheng-Yu YANG, Miao-Li County (TW); Ming-Jou TAI, Miao-Li County (TW); Chih-Hao CHANG, Miao-Li County (TW); Chia-Hao TSAI, Miao-Li County (TW)

(73) Assignee: InnoLux Corporation, Miao-Li County (TW)

(21) Appl. No.: 19/287,800

(22) Filed: Jul. 31, 2025

(30) Foreign Application Priority Data
Sep. 26, 2024 (CN) 202411349182.3

(51) Int. Cl. G02F 1/1335

(52) U.S. Cl. CPC G02F 1/133514

(57) ABSTRACT

An electronic device including a substrate, a circuit layer, an optical filter layer and a medium layer is disclosed. The circuit layer is disposed on the substrate and includes a signal line. The optical filter layer is disposed on the circuit layer and includes a plurality of optical filter patterns. One of the optical filter patterns includes a first arc corner and a second arc corner, and the first arc corner and the second arc corner are adjacent to the signal line. The optical filter layer is disposed between the circuit layer and the medium layer. A curvature radius of the first arc corner is different from a curvature radius of the second arc corner.

### BACKGROUND OF THE DISCLOSURE

### 1. Field of the Disclosure

The present disclosure relates to an electronic device, and more particularly to an electronic device including an optical filter layer that is disposed on a circuit layer.

### 2. Description of the Prior Art

With the progress of science and technology, electronic devices have become indispensable items in modern life. In electronic devices such as virtual reality (VR) devices and liquid crystal display devices, products having pixels with small sizes have higher requirements for alignment accuracy and patterning design of the optical filter layer. Therefore, the architecture design of the optical filter layer in electronic devices is still one of the important topics currently.

### SUMMARY OF THE DISCLOSURE

One of objectives of the present disclosure is to provide an electronic device, wherein through the design that the optical filter pattern of an optical filter layer disposed on a circuit layer having arc corners with different curvatures, light leakage may be reduced and color saturation may be enhanced, thereby improving the display quality of the electronic device.

The present disclosure provides an electronic device including a substrate, a circuit layer, an optical filter layer and a medium layer is disclosed. The circuit layer is disposed on the substrate, and the circuit layer includes a signal line. The optical filter layer is disposed on the circuit layer and, the optical filter layer includes a plurality of optical filter patterns. One of the optical filter patterns includes a first arc corner and a second arc corner, and the first arc corner and the second arc corner are adjacent to the signal line. The optical filter layer is disposed between the circuit layer and the medium layer. A curvature radius of the first arc corner is different from a curvature radius of the second arc corner.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a partial top-view schematic diagram of an electronic device according to a first embodiment of the present disclosure.

FIG. 2A and FIG. 2B are enlarged top-view schematic diagrams of some variant embodiments of an optical filter pattern according to a first embodiment of the present disclosure.

FIG. 3 is a partial top-view schematic diagram of an electronic device according to a second embodiment of the present disclosure.

FIG. 4 is a partial top-view schematic diagram of an electronic device according to a third embodiment of the present disclosure.

FIG. 5 is an enlarged top-view schematic diagram of a variant embodiment of an optical filter pattern according to a third embodiment of the present disclosure.

FIG. 6 is a partial top-view schematic diagram of an electronic device according to a fourth embodiment of the present disclosure.

FIG. 7 is a partial top-view schematic diagram of an electronic device according to a fifth embodiment of the present disclosure.

FIG. 8 is a partial cross-sectional schematic diagram of an electronic device according to a fifth embodiment of the present disclosure.

FIG. 9 is an enlarged top-view schematic diagram of a hole of an optical filter layer according to a fifth embodiment of the present disclosure.

FIG. 10 is a partial cross-sectional schematic diagram of a variant embodiment of an electronic device according to a fifth embodiment of the present disclosure.

FIG. 11 is a partial top-view schematic diagram of an electronic device according to a sixth embodiment of the present disclosure.

FIG. 12 is a partial cross-sectional schematic diagram of an electronic device according to a sixth embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the device or structure, and certain components in various drawings may not be drawn to scale. In addition, the number and dimension of each component shown in drawings are only illustrative and are not intended to limit the scope of the present disclosure.

Certain terms are used throughout the description and following claims to refer to particular components. As one skilled in the art will understand, electronic equipment manufacturers may refer to a component by different names. The present disclosure does not intend to distinguish between components that differ in name but not function. In the following description and in the claims, the terms “include”, “comprise” and “have” are used in an open-ended fashion, and thus should be interpreted to mean “include, but not limited to . . . ”. When the terms “include”, “comprise” and/or “have” are used in the description of the present disclosure, the corresponding features, areas, steps, operations and/or components would be pointed to existence, but not limited to the existence or addition of one or a plurality of the corresponding or other features, areas, steps, operations, components and/or combinations thereof.

When an element or layer is referred to as being “on” or “connected to” another element or layer, it may be directly on or directly connected to the other element or layer, or intervening elements or layers may be presented (indirect condition). In contrast, when an element is referred to as being “directly on” or “directly connected to” another element or layer, there are no intervening elements or layers presented.

The directional terms mentioned in the present disclosure, such as “up”, “down”, “front”, “back”, “left”, “right”, etc., are only directions referring to the drawings. Therefore, the directional terms used are for illustration, not for limitation of the present disclosure.

The ordinal numbers used in the description and claims, such as “first”, “second”, “third”, etc., are used to describe elements, but they do not mean and represent that the element(s) have any previous ordinal numbers, nor do they represent the order of one element and another element, or the order of manufacturing methods. The ordinal numbers are used only to clearly discriminate an element with a certain name from another element with the same name. The claims and the description may not use the same terms. Accordingly, in the following description, a first constituent element may be a second constituent element in a claim.

The terms “equal”, “identical” or “the same”, and “substantially” or “approximately” generally mean being within 20% of a given value or range, or being within 10%, 5%, 3%, 2%, 1% or 0.5% of a given value or range.

In the present disclosure, the length and width of each element and/or the distance between elements may be measured by using an optical microscope (OM), a scanning electron microscope (SEM) or other suitable methods. For example, the length and width of each element and/or the distance between elements may be measured from an image obtained by the scanning electron microscope, but not limited herein.

The electronic device of the present disclosure may be applied to a display device, a virtual reality device, an augmented reality device, a light-emitting device, a backlight device, an antenna device, a sensing device or a tiled device, but not limited herein. The electronic device may include a bendable or flexible electronic device. The electronic device may include, for example, liquid crystal, light-emitting diodes (LEDs), fluorescence, phosphors, other suitable display media or combinations of the above, but not limited herein. The display device may include a non-self-emissive display device or a self-emissive display device. The antenna device may include a liquid-crystal type antenna device or an antenna device other than liquid-crystal type, and the sensing device may include a sensing device used for sensing capacitance, light, heat or ultrasonic waves, but not limited herein. The electronic device may include electronic elements such as passive elements and active elements, for example, capacitors, resistors, inductors, diodes, transistors, etc. The diode may include a light-emitting diode or a photodiode. For example, the light-emitting diode may include an organic light-emitting diode (OLED), a mini light-emitting diode (mini LED), a micro light-emitting diode (micro LED) or a quantum dot light-emitting diode (quantum dot LED), but not limited herein. The tiled device may be, for example, a display tiled device or an antenna tiled device, but not limited herein. It should be noted that the electronic device may be any arrangement and combination of the above, but not limited herein. The electronic device may have a peripheral system such as a driving system, a control system, a light source system, etc., to support a display device, an antenna device, a wearable device (including an augmented reality device or a virtual reality device, for example), a vehicle-mounted device (including an automobile windshield, for example) or a tiled device.

It should be noted that the technical features in different embodiments described in the following can be replaced, recombined, or mixed with one another to constitute another embodiment without departing from the spirit of the present disclosure.

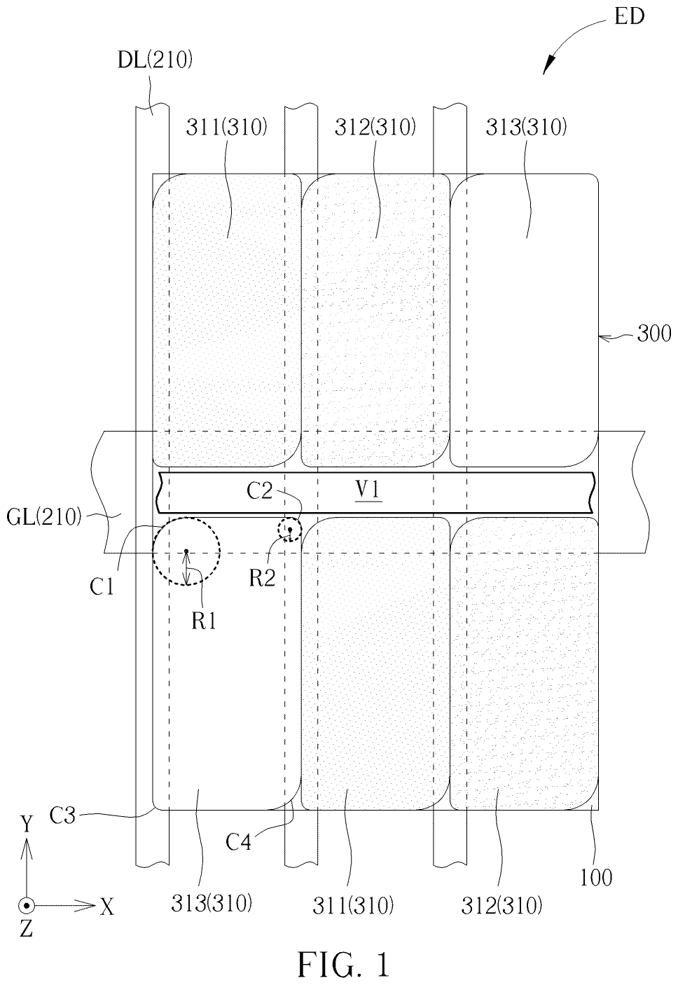

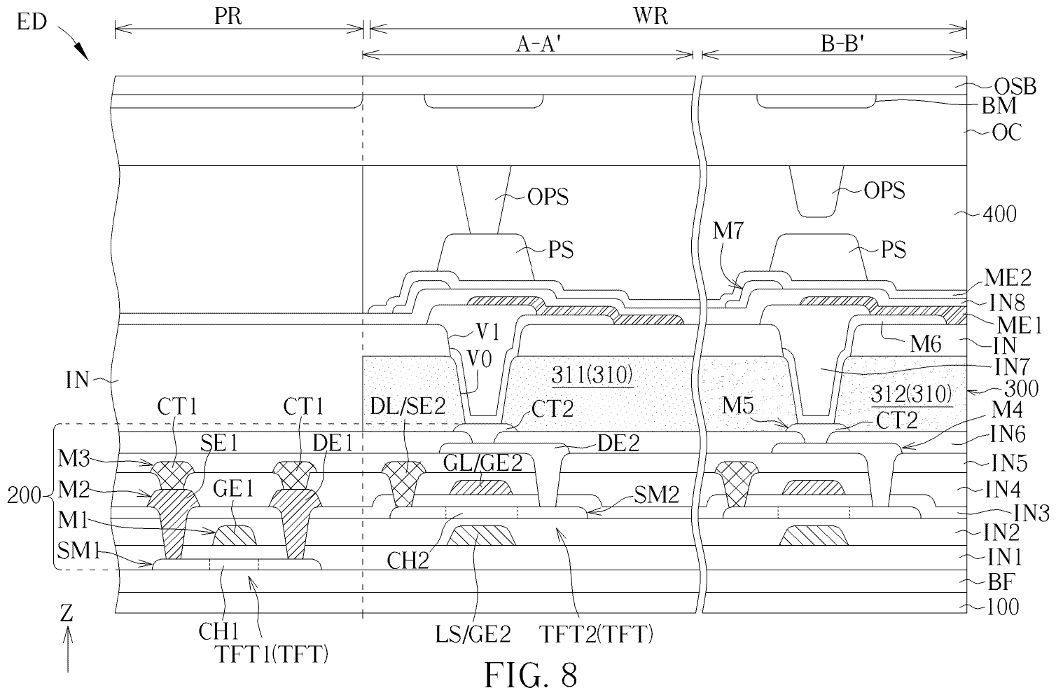

Please refer to FIG. 1, which is a partial top-view schematic diagram of an electronic device according to a first embodiment of the present disclosure. For the conciseness of the drawings, FIG. 1 only shows a top-view of a portion of elements of an electronic device ED, wherein the stacking structure on a substrate 100 along a direction Z of the electronic device ED shown in FIG. 1 may be referred to, for example (but not limited to), the cross-sectional structure shown in FIG. 8. As shown in FIG. 1, in conjunction with FIG. 8, the electronic device ED may include a substrate 100, a circuit layer 200 (shown in FIG. 8), an optical filter layer 300 and a medium layer 400 (shown in FIG. 8). The circuit layer 200 is disposed on the substrate 100, and the circuit layer 200 includes one or more signal line 210. The signal lines 210 may include a scan line GL and a data line DL, the scan line GL may extend along a direction X, and the data line DL may extend along a direction Y, wherein the direction X is not parallel to the direction Y, for example, the direction X may be perpendicular to the direction Y, but not limited herein. The direction Z may be a normal direction of the electronic device ED and parallel to a top-view direction of the electronic device ED and a normal direction of the surface of the substrate 100, i.e., the direction Z may be perpendicular to the upper surface or the lower surface of the substrate 100, and the direction X and the direction Y may be perpendicular to the direction Z, respectively. The substrate 100 may include hard material or flexible material, such as glass, quartz, sapphire, ceramics, polyimide (PI), polycarbonate (PC), polyethylene terephthalate (PET), other suitable materials or combinations of the above materials, but not limited herein.

The optical filter layer 300 is disposed on the circuit layer 200, and the optical filter layer 300 is disposed between the circuit layer 200 and the medium layer 400 in the direction Z (as shown in FIG. 8). By disposing the optical filter layer 300 and the circuit layer 200 on the same side of the medium layer 400, the alignment accuracy of the layers may be improved. The optical filter layer 300 includes a plurality of optical filter patterns 310, one or more of the plurality of optical filter patterns 310 include a first arc corner C1 and a second arc corner C2, and the first arc corner C1 and the second arc corner C2 are adjacent to the signal line 210, wherein a curvature radius R1 of the first arc corner C1 is different from a curvature radius R2 of the second arc corner C2, i.e., the curvature of the first arc corner C1 is different from the curvature of the second arc corner C2. According to the embodiment shown in FIG. 1, the first arc corner C1 and the second arc corner C2 of the optical filter pattern 310 may be adjacent to the scan line GL, and the curvature radius R2 of the second arc corner C2 is less than the curvature radius R1 of the first arc corner C1. The second arc corner C2 may be formed by, for example (but not limited to), the technology of optical proximity correction (OPC) for compensation.

In some embodiments, a plurality of scan lines GL and a plurality of data lines DL may be formed on the substrate 100, the scan lines GL and the data lines DL intersect with each other to define regions of a plurality of pixels (or sub-pixels), and the electronic device ED may have the function of displaying images, but not limited herein. The plurality of optical filter patterns 310 may include a first optical filter pattern 311, a second optical filter pattern 312 and a third optical filter pattern 313, which are capable of filtering light of a specific wavelength band, so as to allow different colors of light to pass through and correspond to different color sub-pixels. For example, the first optical filter pattern 311 may allow red light to pass through and correspond to a red sub-pixel, the second optical filter pattern 312 may allow green light to pass through and correspond to a green sub-pixel, and the third optical filter pattern 313 may allow blue light to pass through and correspond to a blue sub-pixel, but not limited herein. A sub-pixel corresponding to the first optical filter pattern 311, another sub-pixel corresponding to the second optical filter pattern 312 and still another sub-pixel corresponding to the third optical filter pattern 313 may form a pixel, and the electronic device ED may include a plurality of pixels arranged in a pixel array along the direction X and the direction Y, but not limited herein. Each of the optical filter patterns 310 may include a red color resist, a green color resist, a blue color resist, other suitable optical filter elements or any combination of the above. In some embodiments, the plurality of optical filter patterns 310 may further be cooperated with light-emitting elements that emit different colors of light, so that the sub-pixels display different colors, but not limited herein.

As shown in FIG. 1, the electronic device ED may further include a strip-shaped hole V1 extending along the direction X, and the conductive layers located above and below the optical filter layer 300 may be electrically connected with each other through the hole V1, for example, as illustrated in the stacking structure shown in FIG. 8, which will be described in more detail later. In some embodiments, the electronic device ED may further include layers and elements disposed on the substrate 100 such as at least one insulating layer, at least one conductive layer, and/or thin film transistors (e.g., thin film transistors TFT shown in FIG. 8), wherein the thin film transistor may be connected to and control the pixel or sub-pixel corresponding to each of the optical filter patterns 310, serving as switching elements or driving elements. The thin film transistor located below the optical filter layer 300 may be electrically connected to the conductive layer located above the optical filter layer 300 through the hole V1.

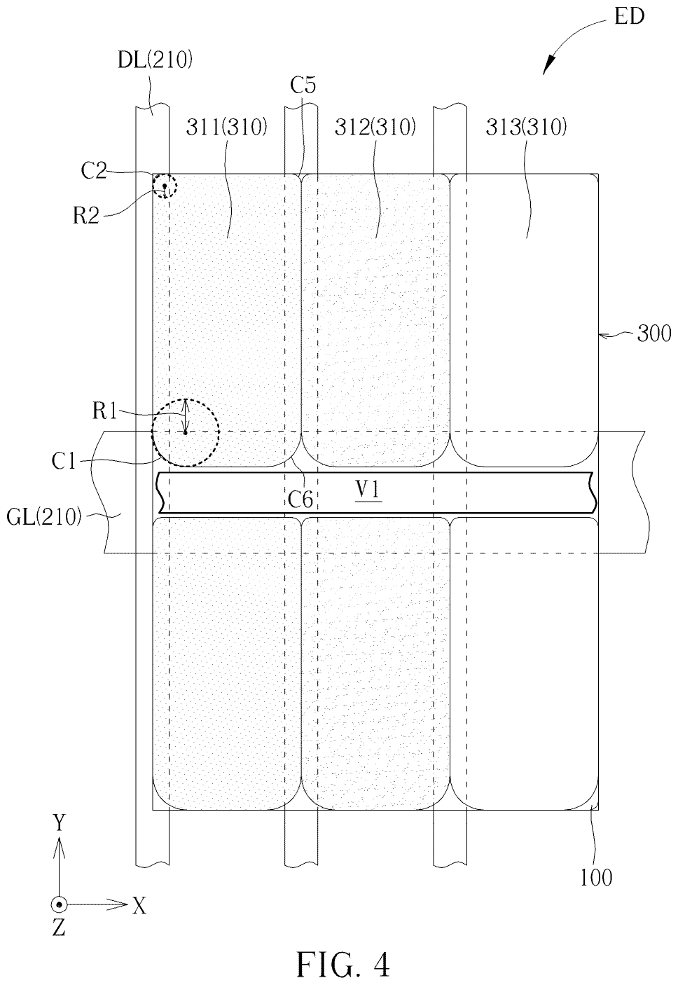

According to the embodiment shown in FIG. 1, the plurality of optical filter patterns 310 may be island-shaped patterns, i.e., the optical filter patterns 310 in the upper and lower horizontal rows may be separated from each other to reduce the area occupied by the optical filter layer 300, so that there is sufficient space between the conductive layers above and below the optical filter layer 300 for electrical connection, thereby reducing the influence on the electrical transfer area. In some embodiments, it may be designed using sub-pixel rendering (SPR) technology, so that a single column includes the optical filter patterns 310 of different colors. For example, the first optical filter patterns 311, the second optical filter patterns 312 and the third optical filter patterns 313 may form the arrangement shown in FIG. 1. However, the present disclosure is not limited to the above. In other embodiments, a single column may include the optical filter patterns 310 with one color, as shown in FIG. 4.

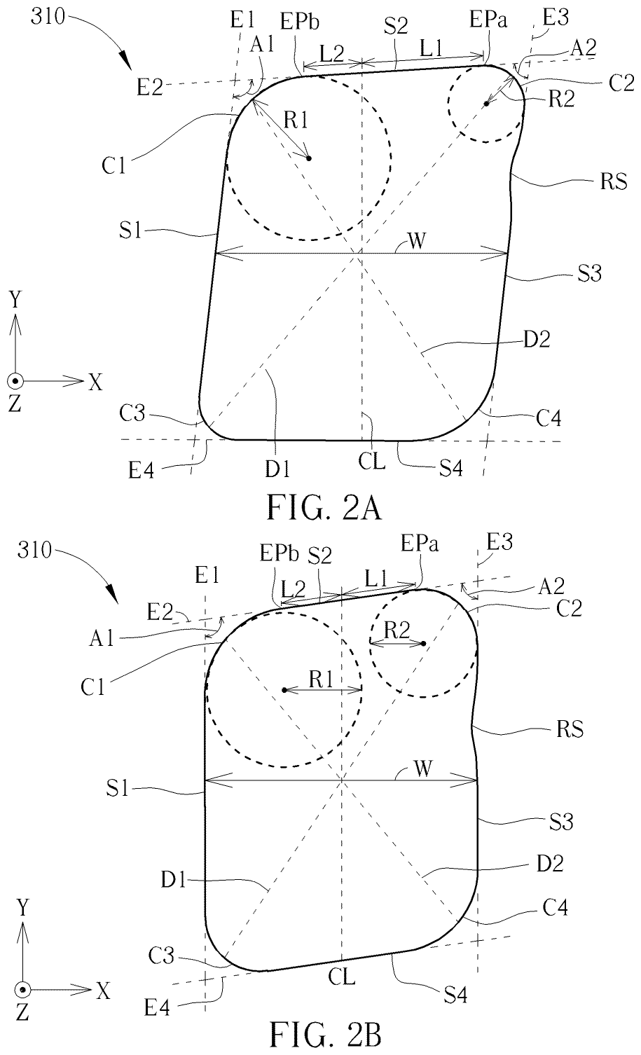

Please refer to FIG. 2A and FIG. 2B, in conjunction with FIG. 1. FIG. 2A and FIG. 2B are enlarged top-view schematic diagrams of some variant embodiments of an optical filter pattern according to a first embodiment of the present disclosure. The optical filter patterns 310 shown in FIG. 2A and FIG. 2B will be described as an example in the following. It should be noted that one or more of the optical filter patterns 310 shown in FIG. 1 may also meet the following detailed structural features. As shown in FIG. 2A and FIG. 2B, the optical filter pattern 310 may include a first edge S1, a second edge S2 and a third edge S3, the first arc corner C1 is connected between the first edge S1 and the second edge S2, and the second arc corner C2 is connected between the second edge S2 and the third edge S3. The first edge S1 is opposite to the third edge S3, the second edge S2 is connected between the first edge S1 and the third edge S3, and the curvature radius R2 of the second arc corner C2 may be less than the curvature radius R1 of the first arc corner C1. A first included angle A1 corresponding to the first arc corner C1 exists between an extension line E1 of the first edge S1 and an extension line E2 of the second edge S2, a second included angle A2 corresponding to the second arc corner C2 exists between the extension line E2 of the second edge S2 and an extension line E3 of the third edge S3, and the first included angle A1 and the second included angle A2 are both less than 180 degrees, wherein the first included angle A1 is greater than 90 degrees, and the second included angle A2 is less than 90 degrees. That is to say, the first included angle A1 is an obtuse angle, and the second included angle A2 is an acute angle. In some embodiments, the edge of the optical filter pattern 310 connected to the second arc corner C2 may further include a recess RS, for example, the third edge S3 may include the recess RS, but not limited herein.

According to the embodiment shown in FIG. 2A and FIG. 2B, the optical filter pattern 310 has a maximum width W in the direction X. For example, the longest distance between the first edge S1 and the second edge S2 in the direction X may be defined as the maximum width W. An end EPa of the second edge S2 is connected to the second arc corner C2, and a central line CL perpendicular to the direction X may defined at a position where the optical filter pattern 310 has the maximum width W, wherein a length L1 of the second edge S2 from the end EPa to the central line CL is greater than or equal to one-sixth of the maximum width W (i.e., L1≥W*⅙). The second edge S1 further includes another end EPb opposite to the end EPa, and the another end EPb is connected to the first arc corner C1, wherein a length L2 of the second edge S2 from the another end EPb to the central line CL is less than one-sixth of the maximum width W (i.e., L2<W*⅙). In other words, when the distance between an end of the second edge S2 and the central line CL is greater than or equal to W*⅙, the arc corner connected with this end is defined as the second arc corner C2; when the distance between an end of the second edge S2 and the central line CL is less than W*⅙, the arc corner connected with this end is defined as the first arc corner C1.

According to the above embodiments shown in FIG. 1, FIG. 2A and FIG. 2B, one or more of the optical filter patterns 310 of the optical filter layer 300 disposed on the circuit layer 200 have specific pattern design, which has the first arc corner C1 and the second arc corner C2 with different radii of curvature, so that the light leakage may be reduced, and the color saturation may be enhanced, thereby improving the display quality of the electronic device ED.

As shown in FIG. 1, FIG. 2A and FIG. 2B, in some embodiments, the optical filter pattern 310 may further include another arc corner C3 (which may be referred to as a third arc corner), and the arc corner C3 and the second arc corner C2 are located on two opposite sides of a diagonal line D1 of the optical filter pattern 310, wherein the curvature radius of the arc corner C3 is less than the curvature radius R1 of the first arc corner C1. The arc corner C3 may be formed by, for example (but not limited to), the technology of optical proximity correction for compensation. The optical filter pattern 310 may further have another diagonal line D2, and a length of the diagonal line D2 is different from a length of the diagonal line D1. For example, the length of the diagonal line D1 may be greater than the length of the diagonal line D2. In some embodiments, the optical filter pattern 310 may further include still another arc corner C4, and the arc corner C4 and the first arc corner C1 are located on two opposite sides of the diagonal line D2, wherein the curvature radius of the arc corner C4 is greater than the curvature radii of the second arc corner C2 and the arc corner C3. Specifically, the optical filter pattern 310 may include a fourth edge S4 opposite to the second edge S2, the arc corner C3 is connected between the first edge S1 and the fourth edge S4, and the arc corner C4 is connected between the fourth edge S4 and the third edge S3. An extension line E4 of the fourth edge S4, the extension line E1, the extension line E2 and the extension line E3 may form the smallest quadrilateral surrounding the optical filter pattern 310. Referring to the positional relationship of the second arc corner C2, the first arc corner C1 and the corresponding edges, the arc corner C3 may have detailed structural features similar to those of the second arc corner C2, and the arc corner C4 may have detailed structural features similar to those of the first arc corner C1, which will not be described redundantly herein.

According to the structural design of the optical filter patterns 310 shown in FIG. 1, FIG. 2A and FIG. 2B, two adjacent optical filter patterns 310 (e.g., the first optical filter pattern 311 and the adjacent second optical filter pattern 312) may have arc corners with smaller radii of curvature (i.e., the second arc corner C2 and the arc corner C3) on two sides of the diagonal line D1 respectively and arc corners with larger radii of curvature (i.e., the first arc corner C1 and the arc corner C4) on two sides of the diagonal line D2 respectively, thereby reducing the risk of overlap between two adjacent optical filter patterns 310 at the corners. The overlap of the patterns may result in an excessively thick layer, which may affect the planarization ability of the insulating layer covering the optical filter layer 300 (e.g., an insulating layer IN shown in FIG. 8).

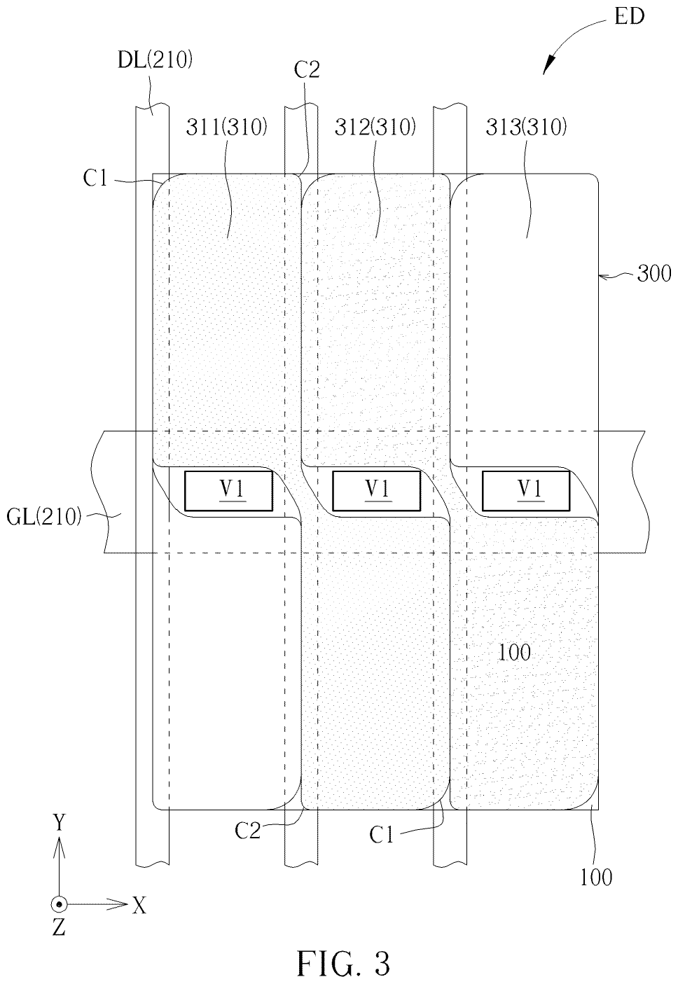

Please refer to FIG. 3, which is a partial top-view schematic diagram of an electronic device according to a second embodiment of the present disclosure. The electronic device ED of the second embodiment shown in FIG. 3 is different form the first embodiment shown in FIG. 1 in that, aside from the diagonal line with the second arc corner C2 on one side, in a direction of the other diagonal line, one corner of each of the optical filter patterns 310 that allow the same color light to pass through may be connected with each other. Furthermore, the electronic device ED may include a plurality of holes V1 separated from each other, and the conductive layers located above and below the optical filter layer 300 may be electrically connected with each other through the plurality of holes V1. Specifically, as shown in FIG. 3, the corners of two adjacent first optical filter patterns 311 may be connected with each other, wherein the connected corners are located on a side of the diagonal line. Similarly, the second optical filter patterns 312 may be connected to each other, and the third optical filter patterns 313 may be connected to each other, but not limited herein.

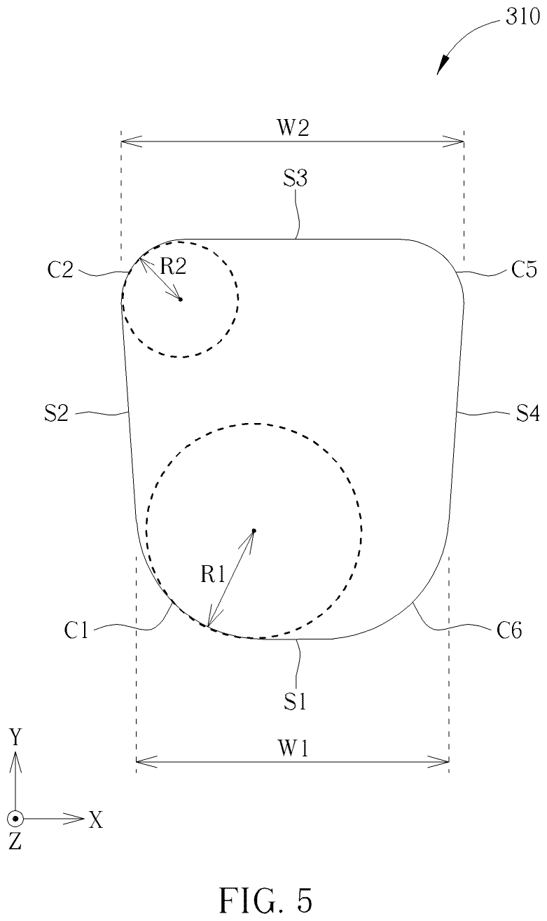

Please refer to FIG. 4 and FIG. 5. FIG. 4 is a partial top-view schematic diagram of an electronic device according to a third embodiment of the present disclosure. FIG. 5 is an enlarged top-view schematic diagram of a variant embodiment of an optical filter pattern according to a third embodiment of the present disclosure, wherein the optical filter pattern 310 shown in FIG. 5 may be applied in the electronic device ED shown in FIG. 4. According to the embodiment shown in FIG. 4 and FIG. 5, the first arc corner C1 and the second arc corner C2 of the optical filter pattern 310 may be adjacent to the data line DL, wherein the curvature radius R2 of the second arc corner C2 is less than the curvature radius R1 of the first arc corner C1. The second arc corner C2 may be formed by, for example (but not limited to), the technology of optical proximity correction for compensation. The optical filter pattern 310 includes the first arc corner C1 and the second arc corner C2 with different radii of curvature, so that the light leakage may be reduced, and the color saturation may be enhanced, thereby improving the display quality of the electronic device ED. In some embodiments, the optical filter pattern 310 may further include another arc corner C5, and the second arc corner C2 and the arc corner C5 are located on the same side of the optical filter pattern 310, wherein the curvature radius of the arc corner C5 is less than the curvature radius R1 of the first arc corner C1. The arc corner C5 may be formed by, for example (but not limited to), the technology of optical proximity correction for compensation. In some embodiments, the optical filter pattern 310 may further include still another arc corner C6 (which may be referred to as a fourth arc corner), the first arc corner C1 and the arc corner C6 are located on the same side of the optical filter pattern 310, wherein a curvature radius of the arc corner C6 is greater than the curvature radius R2 of the second arc corner C2.

As shown in FIG. 5, a width W1 on a side of the optical filter pattern 310 is different from a width W2 on another side of the optical filter pattern 310. For example, the longest distance between the first arc corner C1 and the arc corner C6 in the direction X may be defined as the width W1, the longest distance between the second arc corner C2 and the arc corner C5 in the direction X may be defined as the width W2, and the width W1 may be less than the width W2. The optical filter pattern 310 may include a first edge S1, a second edge S2, a third edge S3 and a fourth edge S4. The first arc corner C1 is connected between the first edge S1 and the second edge S2, the second arc corner C2 is connected between the second edge S2 and the third edge S3, the arc corner C5 is connected between the third edge S3 and the fourth edge S4, and the arc corner C6 is connected between the fourth edge S4 and the first edge S1. The detailed structural features related to each arc corner and the extension lines of the corresponding edges of the optical filter pattern 310 may be referred to the first embodiment, which will not be described redundantly herein.

As shown in FIG. 4, the electronic device ED may include a strip-shaped hole V1 extending along the direction X, the thin film transistor (e.g. the thin film transistor TFT shown in FIG. 8) may be connected to and control the sub-pixel corresponding to each of the optical filter patterns 310 through the hole V1. For example, the sub-pixel corresponding to the first optical filter pattern 311 may be connected to the thin film transistor through the hole V1 at the lower side of first optical filter pattern 311 for signal transmission. According to the structural design of the optical filter pattern 310 shown in FIG. 4 and FIG. 5, a side of the optical filter pattern 310 having arc corners with smaller curvature radii (i.e., the second arc corner C2 and the arc corner C5) may be opposite to the position where the sub-pixel is connected to the thin film transistor, and a side of the optical filter pattern 310 having arc corners with larger curvature radii (i.e., the first arc corner C1 and the arc corner C6) may be adjacent to the position where the corresponding sub-pixel is connected to the thin film transistor. That is to say, the optical filter pattern 310 has a small area on the side where the sub-pixel is connected to the thin film transistor for signal transmission, so that the insulating layer covering the optical filter layer 300 (e.g. the insulating layer IN shown in FIG. 8) may have a good planarization ability, and the risk of disconnection of the wires formed by the conductive layers located above the optical filter layer 300 may be reduced.

According to the embodiment shown in FIG. 4, the plurality of optical filter patterns 310 may be island-shaped patterns, i.e., the optical filter patterns 310 in the upper and lower horizontal rows may be separated from each other to reduce the area occupied by the optical filter layer 300. In some embodiments, as shown in FIG. 4, a single column may include the optical filter patterns 310 with one color, i.e., one column may include a plurality of first optical filter patterns 311, another column may include a plurality of second optical filter patterns 312, and still another column may include a plurality of third optical filter patterns 313, but not limited herein.

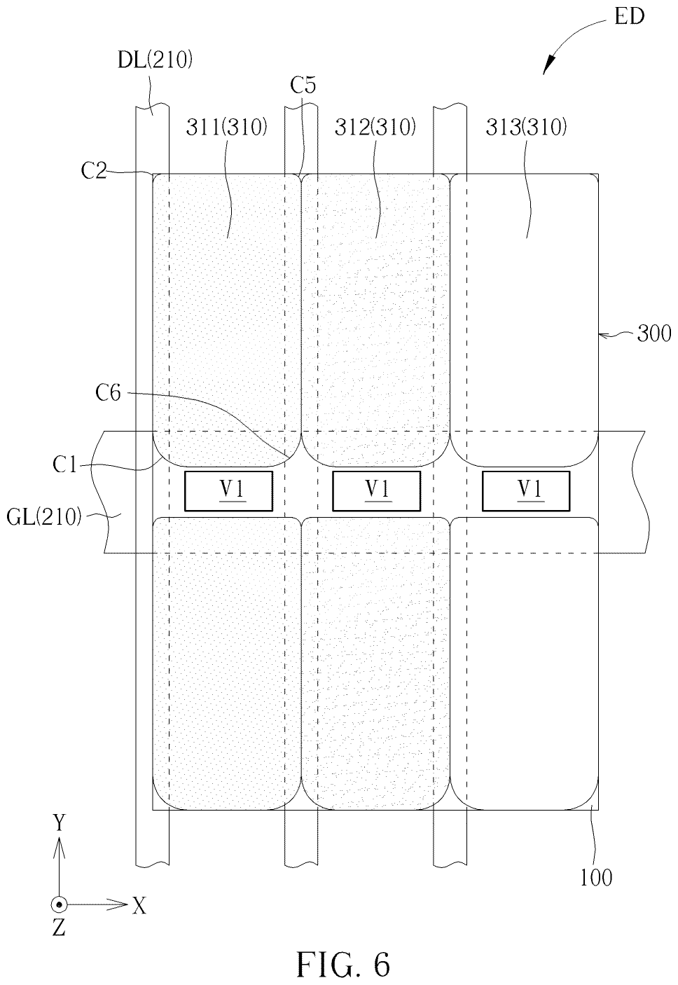

Please refer to FIG. 6, which is a partial top-view schematic diagram of an electronic device according to a fourth embodiment of the present disclosure. The electronic device ED of the fourth embodiment shown in FIG. 6 is different form the third embodiment shown in FIG. 5 in that, the electronic device ED may include a plurality of holes V1 separated from each other, and the conductive layers located above and below the optical filter layer 300 may be electrically connected with each other through the plurality of holes V1. For example, the sub-pixels corresponding to the first optical filter pattern 311, the second optical filter pattern 312 and the third optical filter pattern 313 may be respectively connected to the thin film transistors through the holes V1 at the lower side thereof for signal transmission.

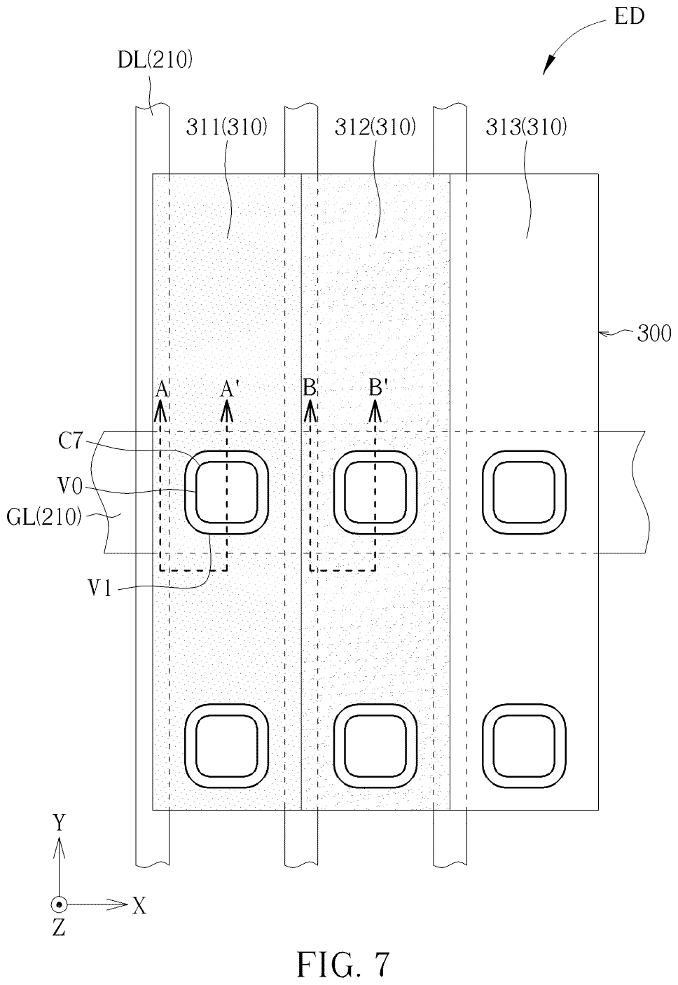

Please refer to FIG. 7 and FIG. 8. FIG. 7 is a partial top-view schematic diagram of an electronic device according to a fifth embodiment of the present disclosure. FIG. 8 is a partial cross-sectional schematic diagram of an electronic device according to a fifth embodiment of the present disclosure. FIG. 7 only shows a top-view of a portion of elements of an electronic device ED shown in FIG. 8, and the partial cross-sectional structure of the electronic device ED corresponding to the section line A-A′ and the section line B-B′ in FIG. 7 may be referred to FIG. 8. As shown in FIG. 7 and FIG. 8, the electronic device ED may include the substrate 100 and the circuit layer 200, the optical filter layer 300, the insulating layer IN, a conductive layer ME1 and the medium layer 400 which are disposed on the substrate 100 along the direction Z. The circuit layer 200 includes the signal lines 210 and the thin film transistors TFT, and the signal lines 210 may include the scan lines GL extending along the direction X and the data lines DL extending along the direction Y. The optical filter layer 300 may include a plurality of optical filter patterns 310, including, for example, a color first filter pattern 311, a second optical filter pattern 312 and a color third filter pattern 313 which respectively extend along the direction Y, and the optical filter layer 300 has a hole V0, wherein the hole V0 includes one or more arc corners C7. The arc corner C7 may be formed by, for example (but not limited to), the technology of optical proximity correction for compensation. The insulating layer IN has the hole V1, which may be at least partially overlapped with the hole V0 in the direction Z, and the conductive layer ME1 may be electrically connected to the thin film transistor TFT through the hole V1 and the hole V0. For example, the conductive layer ME1 may be electrically connected to the thin film transistor TFT through a conductive layer M6 which is partially filled in the hole V1 and the hole V0 and used for bridging. The conductive layer ME1 may be used as a pixel electrode. The insulating layer IN may be used as a planarization layer, so as to facilitate the arrangement of other elements or layers thereon. According to the above structural design, the hole V0 of the optical filter layer 300 has an arc corner C7, so that the adhesion of the optical filter layer 300 may be improved, and the area of electrical layer transfer may be increased.

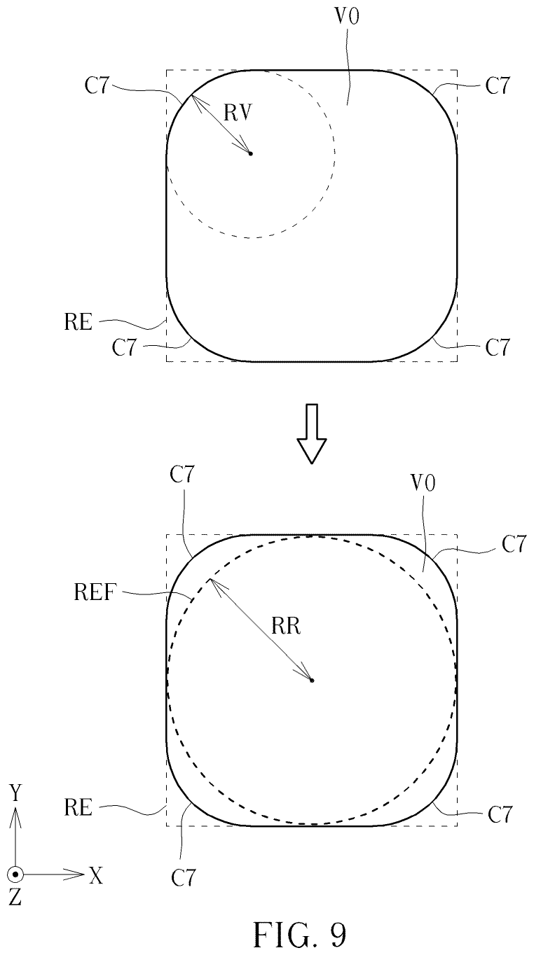

Please refer to FIG. 9, which is an enlarged top-view schematic diagram of a hole of an optical filter layer according to a fifth embodiment of the present disclosure. As shown in FIG. 9, taking the top-view pattern of the hole V0 of the optical filter layer 300 as the center, the smallest rectangle RE surrounding the hole V0 may be obtained by extending the sides in the directions parallel to the direction X and the direction Y, and the smallest circle or ellipse inside the rectangle RE may be obtained as a reference pattern REF by taking four sides of the rectangle RE as boundaries. In a top-view, an area of the hole V0 is greater than an area of the reference pattern REF. When the reference pattern REF is circular, the curvature radius RV of the arc corner C7 of the hole V0 may be less than the radius RR of the reference pattern REF; when the reference pattern REF is elliptical, the curvature radius RV of the arc corner C7 of the hole V0 may be less than half of the short axis of the reference pattern REF. In some embodiments, as shown in FIG. 9, the hole V0 may include four arc corners C7 on two diagonal lines thereof, but the present disclosure is not limited herein. In other embodiments, the hole V0 may include two arc corners C7 on the same side (e.g., the upper side or the lower side).

According to the embodiment shown in FIG. 7 and FIG. 8, the circuit layer 200 may include a semiconductor layer SM1, an insulating layer IN1, a conductive layer M1, an insulating layer IN2, a semiconductor layer SM2, an insulating layer IN3, a conductive layer M2, an insulating layer IN4, a conductive layer M3, an insulating layer IN5, a conductive layer M4, an insulating layer IN6, and a conductive layer M5 which are disposed on the substrate 100 along the direction Z in sequence. A portion of the conductive layer M2 may form the scan lines GL among the signal lines 210, and a portion of the conductive layer M3 may form the data lines DL among the signal lines 210. The circuit layer 200 may include a plurality of thin film transistors TFT, which may include a first thin film transistor TFT1 disposed in a peripheral region PR of the electronic device ED and a second thin film transistor TFT2 disposed in a working region WR of the electronic device ED. When the electronic device ED is a display device with a display function, the working region WR may be a display region and include a plurality of pixels (or sub-pixels), and the peripheral region PR may be a non-display region. In some embodiments, the electronic device ED may further optionally include a buffer layer BF disposed between the substrate 100 and the circuit layer 200. It should be noted that the structure of the circuit layer 200 shown in FIG. 8 is only exemplary and is not limited to the above.

The first thin film transistor TFT1 may include the semiconductor layer SM1, a gate GE1, a source SE1, and a drain DE1. The semiconductor layer SM1 may include a channel region CH1, the gate GE1 is disposed above the semiconductor layer SM1 and overlapped with the channel region CH1, and the source SE1 and the drain DE1 are respectively electrically connected to two opposite sides of the channel region CH1. The gate GE1 may be formed of the conductive layer M1, and the source SE1 and the drain DE1 may be formed of the conductive layer M2. The insulating layer IN1 may be used as the gate insulating layer of the first thin film transistor TFT1. The semiconductor layer SM1 may include, for example (but not limited to), low temperature polycrystalline silicon (LTPS). In some embodiments, the circuit layer 200 may further include a contact element CT1 formed of the conductive layer M3, and the contact element CT1 may be electrically connected to the source SE1 and the drain DE1 of the first thin film transistor TFT1, so that the first thin film transistor TFT1 may be electrically connected to external electronic components through the contact element CT1.

The second thin film transistor TFT2 may include the semiconductor layer SM2, a gate GE2, a source SE2, and a drain DE2. The semiconductor layer SM2 may include a channel region CH2, the gate GE2 is disposed above the semiconductor layer SM2 and overlapped with the channel region CH2, and the source SE2 and the drain DE2 are respectively electrically connected to two opposite sides of the channel region CH2. The gate GE2 may be formed of the conductive layer M2, the source SE2 may be formed of the conductive layer M3, and the drain DE2 may be formed of the conductive layer M4. The insulating layer IN3 may be used as the gate insulating layer of the second thin film transistor TFT2. The semiconductor layer SM2 may include metal oxide, such as indium gallium zinc oxide (IGZO), but not limited herein. In some embodiments, the circuit layer 200 may further include a light shielding layer LS formed of the conductive layer M1, and the light shielding layer LS may be disposed corresponding to the channel region CH2 of the semiconductor layer SM2. In some embodiments, the light shielding layer LS may be used as another gate GE2 of the second thin film transistor TFT2, i.e., the second thin film transistor TFT2 may be a dual gate thin film transistor. In some embodiments, the circuit layer 200 may further include a contact element CT2 formed of the conductive layer M5, and the contact element CT2 may be electrically connected to the drain DE2 of the second thin film transistor TFT2.

As shown in FIG. 7 and FIG. 8, the electronic device ED may further include the optical filter layer 300, the insulating layer IN, a conductive layer M6, an insulating layer IN7, the conductive layer ME1, an insulating layer IN8, and a conductive layer ME2 disposed on the circuit layer 200 along the direction Z in sequence. The conductive layer M6 may be filled in the hole V1 of the insulating layer IN and the hole V0 of the optical filter layer 300 and in contact with the contact element CT2, so that the conductive layer M6 may be electrically connected to the second thin film transistor TFT2 (or the drain DE2 of the second thin film transistor TFT2) through the contact element CT2. The insulating layer IN7 may be filled in the hole V1 and the hole V0 and cover the conductive layer M6. The insulating layer IN7 may be used as a planarization layer to facilitate the arrangement of other layers (such as the conductive layer ME1) thereon. The conductive layer ME1 may be in contact with and electrically connected to the conductive layer M6, so that the conductive layer ME1 may be electrically connected to the drain DE2 of the second thin film transistor TFT2 through the conductive layer M6 and the contact element CT2. The conductive layer ME1 may be used as a pixel electrode, and the conductive layer ME2 may be used as a common electrode. In some embodiments, as shown in FIG. 8, the electronic device ED may further include a conductive layer M7 disposed between the insulating layer IN8 and the conductive layer ME2, and the conductive layer M7 may be partially overlapped with the data line DL and/or the scan line GL in the direction Z. The conductive layer M7 may reduce the resistance of the conductive layer ME2 used as the common electrode and improve the voltage uniformity thereof, and at the same time, the conductive layer M7 may further provide a light shielding function to reduce the color mixing of adjacent pixels with different colors at oblique viewing angles.

According to the embodiment shown in FIG. 8, the conductive layer M1, the conductive layer M2, the conductive layer M3, the conductive layer M5 and the conductive layer M7 may include any suitable conductive material, such as metal material, but not limited herein. In some embodiments, the conductive layer M7 may further be replaced by a non-conductive layer with light-shielding effect, such as (but not limited to) including black photoresist material or other materials with better light absorption. The conductive layer M4, the conductive layer M6, the conductive layer ME1 and the conductive layer ME2 may include transparent conductive material, such as indium tin oxide (ITO), but not limited herein. The insulating layer IN, the insulating layer IN1, the insulating layer IN2, the insulating layer IN3, the insulating layer IN4, the insulating layer IN5, the insulating layer IN6, the insulating layer IN7, the insulating layer IN8 and the insulating layer IN9 may include any suitable organic insulating material or inorganic insulating material.

As shown in FIG. 8, the electronic device ED may further include another substrate OSB, which is disposed opposite to the substrate 100, and the medium layer 400 may be disposed between the conductive layer ME2 and the substrate OSB. The material of the substrate OSB may be referred to the material of the substrate 100 described above. The medium layer 400 may include, for example, liquid crystal material as a display medium layer, but not limited herein. In some embodiments, a plurality of spacers may be disposed in the medium layer 400 to maintain the gap between the layers. Specifically, the electronic device ED may include a plurality of first spacers PS disposed on the conductive layer ME2 and a plurality of second spacers OPS disposed opposite to the first spacers PS. For example, during the manufacturing process, a light shielding layer BM may be disposed on the substrate OSB first, then a protective layer OC may be disposed on the substrate OSB, and the plurality of second spacers OPS may be disposed on the protective layer OC, wherein the patterns of the light shielding layer BM may correspond to the second spacers OPS. Then, the substrate OSB and the substrate 100 may be assembled in opposite, so that the plurality of second spacers OPS may be correspondingly overlapped with the plurality of first spacers PS in the direction Z, respectively. The second spacer OPS may or may not be in contact with the corresponding first spacer PS.

According to the electronic device ED shown in FIG. 7 and FIG. 8, The manufacturing method of the hole V0 of the optical filter layer 300 and the hole V1 of the insulating layer IN may include the following steps. In some embodiments, first, the optical filter layer 300 may be patterned to form a plurality of optical filter patterns 310 and a plurality of holes V0 with arc corners C7, and then the insulating layer IN may be formed and patterned to form a plurality of holes V1, and each of the holes V1 may be overlapped with one hole V0 in the direction Z. Both the optical filter layer 300 and the insulating layer IN may include photoresist material and may be patterned directly by the photolithography process. In other embodiments, protective photoresists may be respectively formed on the optical filter layer 300 and the insulating layer IN, and then the patterns may be defined by the photolithography process for the protective photoresists, and the optical filter layer 300 and the insulating layer IN may be patterned (including the etching process, for example) respectively to form the holes V0 with arc corners C7 and the holes V1. In further other embodiments, first, the optical filter layer 300 may be patterned to form a plurality of optical filter patterns 310, then the insulating layer IN may be formed and patterned to form a plurality of holes V1, and then a protective photoresist may be formed on the insulating layer IN. Then, the optical filter layer 300 may be patterned (including the etching process, for example) to form a plurality of holes V0 with arc corners C7, and then the protective photoresist may be removed, wherein the above step of forming the protective photoresist may also be omitted in other embodiments.

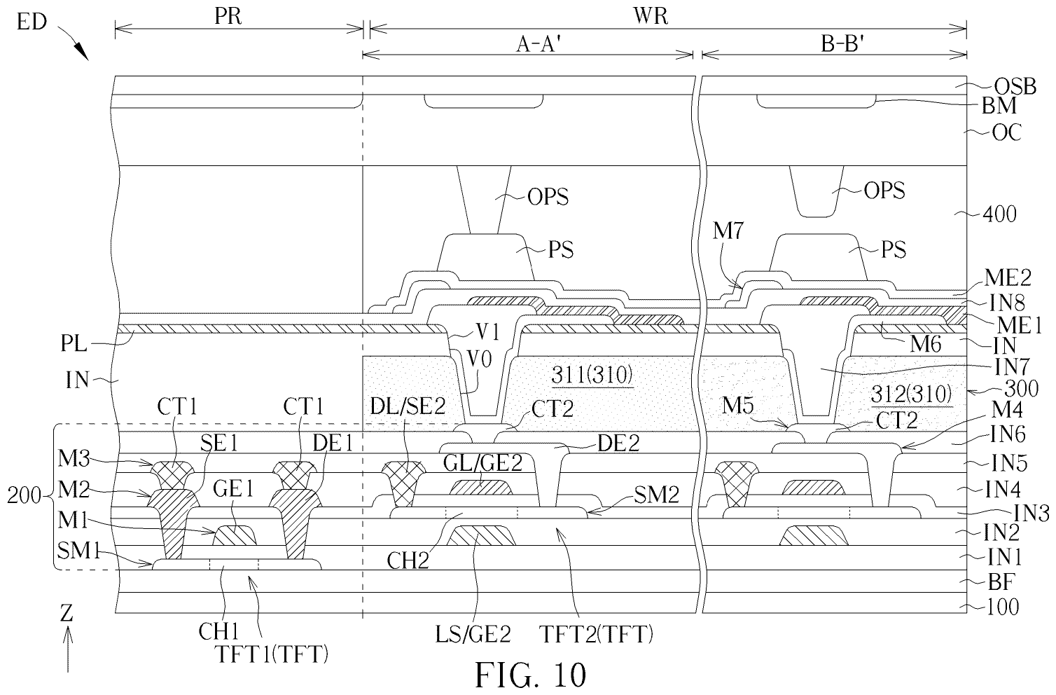

Please refer to FIG. 10, which is a partial cross-sectional schematic diagram of a variant embodiment of an electronic device according to a fifth embodiment of the present disclosure, wherein the top-view schematic diagram of an electronic device ED corresponding to the cross-sectional structure of the section line A-A′ and the section line B-B′ in FIG. 10 may be referred to FIG. 7. The electronic device ED shown in FIG. 10 is different form the fifth embodiment shown in FIG. 8 in that, the electronic device ED may further include a protective layer PL disposed on the insulating layer IN, wherein the protective layer PL includes, for example (but not limited to), silicon nitride (SiNx). According to the electronic device ED shown in FIG. 10, the manufacturing method of the hole V0 of the optical filter layer 300 and the hole V1 of the insulating layer IN may include the following steps. First, a plurality of optical filter patterns 310 of the optical filter layer 300 may be formed, and then the insulating layer IN may be formed and patterned to form a plurality of holes V1. Then, the protective layer PL may be formed on the insulating layer IN, then a protective photoresist may be formed on the protective layer PL, and then the protective layer PL and the optical filter layer 300 may be patterned (including the etching process, for example) to form a plurality of holes V0 with arc corners C7. In this embodiment, the conductive layer M6 partially covers the hole V1. In other embodiments, the conductive layer M6 may completely cover the hole V1, but not limited herein.

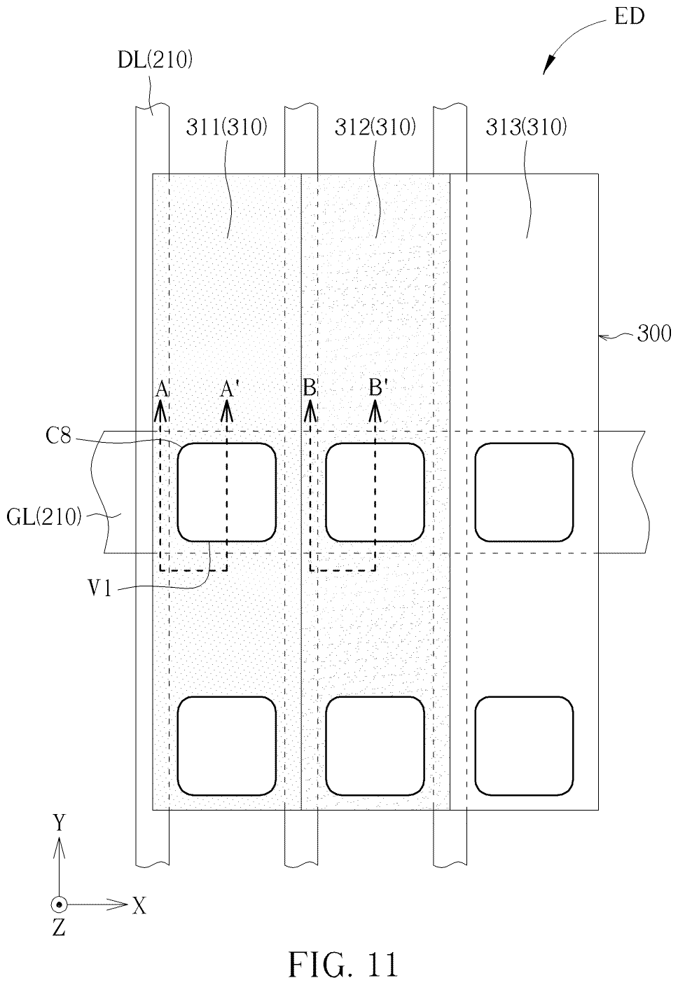

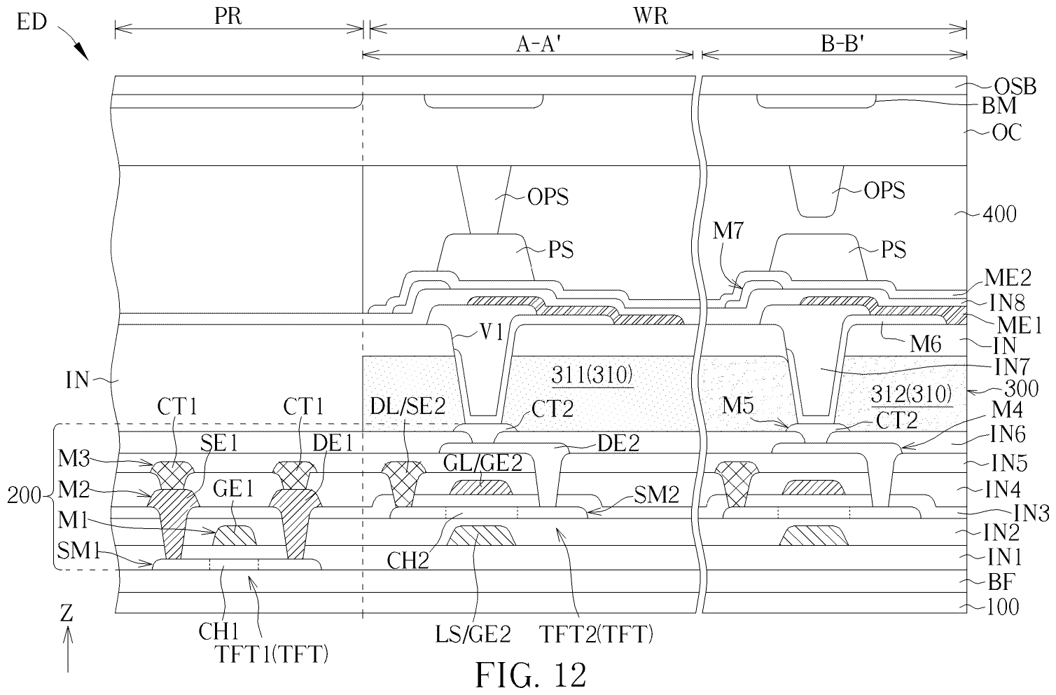

Please refer to FIG. 11 and FIG. 12. FIG. 11 is a partial top-view schematic diagram of an electronic device according to a sixth embodiment of the present disclosure. FIG. 12 is a partial cross-sectional schematic diagram of an electronic device according to a sixth embodiment of the present disclosure. FIG. 11 only shows a top-view of a portion of elements of an electronic device ED shown in FIG. 12, and the partial cross-sectional structure of the electronic device ED corresponding to the section line A-A′ and the section line B-B′ in FIG. 11 may be referred to FIG. 12. The sixth embodiment shown in FIG. 11 and FIG. 12 is different form the fifth embodiment shown in FIG. 7 and FIG. 8 in that, the insulating layer IN and the optical filter layer 300 have holes V1, i.e., the side wall of each of the holes V1 may pass through the insulating layer IN and the optical filter layer 300, and the conductive layer ME1 (or the conductive layer M6) may be electrically connected to the thin film transistor TFT through the hole V1 in the insulating layer IN and the optical filter layer 300. The hole V1 may include one or more arc corners C8, so that the adhesion of the optical filter layer 300 may be improved, and the area of electrical layer transfer may be increased. The arc corner C8 may be formed by, for example (but not limited to), the technology of optical proximity correction to perform compensation. According to the hole V1, the corresponding minimum rectangle and reference pattern and the curvature radius of the arc corner C8 thereof may be obtained, wherein the detailed description may be referred to the above method shown in FIG. 9, which will not be described redundantly herein.

According to the electronic device ED shown in FIG. 11 and FIG. 12, the manufacturing method of the holes V1 of the optical filter layer 300 and the insulating layer IN may include the following steps. In some embodiments, first, the optical filter layer 300 may be patterned to form a plurality of optical filter patterns 310, then the insulating layer IN may be formed, and then the insulating layer IN and the optical filter layer 300 may be patterned to form a plurality of holes V1 with arc corners C8. In other embodiments, first, the optical filter layer 300 may be patterned to form a plurality of optical filter patterns 310, then the insulating layer IN and the protective layer (such as the protective layer PL shown in FIG. 9) may be formed in sequence, then the protective photoresist may be formed on the protective layer PL, and then the protective layer PL, the insulating layer IN and the optical filter layer 300 may be patterned (including the etching process, for example) to form a plurality of holes V1 with arc corners C8. In further other embodiments, first, the optical filter layer 300 may be patterned to form a plurality of optical filter patterns 310, then the insulating layer IN and the protective photoresist may be formed in sequence, then the insulating layer IN and the optical filter layer 300 may be patterned (including the etching process, for example) to form a plurality of holes V1 with arc corners C8, and then the protective photoresist may be removed.

From the above description, according to the electronic devices of the embodiments of the present disclosure, through the design that the optical filter pattern of the optical filter layer disposed on the circuit layer having arc corners with different curvatures, the light leakage may be reduced, and the color saturation may be enhanced, thereby improving the display quality of the electronic device. Furthermore, according to the pattern designs of the optical filter pattern of different embodiments, the risk of layer overlap may be reduced, the influence on the electrical transfer area may be decreased, and/or the risk of wire disconnection may be decreased. In addition, through the design of the holes in the optical filter layer and/or the insulating layer with arc corners, the adhesion of the optical filter layer may be improved, and the area of electrical layer transfer may be increased.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a substrate;
a circuit layer disposed on the substrate and comprising a signal line;
an optical filter layer disposed on the circuit layer and comprising a plurality of optical filter patterns, wherein one of the optical filter patterns comprises a first arc corner and a second arc corner, and the first arc corner and the second arc corner are adjacent to the signal line; and
a medium layer, wherein the optical filter layer is disposed between the circuit layer and the medium layer,
wherein a curvature radius of the first arc corner is different from a curvature radius of the second arc corner.

2. The electronic device according to claim 1, wherein the one of the optical filter patterns further comprises a first edge, a second edge and a third edge, the first arc corner is connected between the first edge and the second edge, and the second arc corner is connected between the second edge and the third edge,
wherein a first included angle corresponding to the first arc corner exists between an extension line of the first edge and an extension line of the second edge, a second included angle corresponding to the second arc corner exists between the extension line of the second edge and an extension line of the third edge, and the first included angle and the second included angle are both less than 180 degrees.

3. The electronic device according to claim 2, wherein the first included angle is greater than 90 degrees, and the second included angle is less than 90 degrees.

4. The electronic device according to claim 1, wherein the one of the optical filter patterns further comprises an edge connected to the second arc corner, and the edge comprises a recess.

5. The electronic device according to claim 1, wherein a width on a side of the one of the optical filter patterns is different from a width on another side of the one of the optical filter patterns.

6. The electronic device according to claim 1, wherein the one of the optical filter patterns has a maximum width W in a direction and further comprises an edge, an end of the edge is connected to the second arc corner, and a central line perpendicular to the direction is defined at a position where the optical filter pattern has the maximum width W, wherein a length of the edge from the end to the central line is greater than or equal to one-sixth of W.

7. The electronic device according to claim 6, wherein the edge further comprises another end opposite to the end, and the another end is connected to the first arc corner, wherein a length of the edge from the another end to the central line is less than one-sixth of W.

8. The electronic device according to claim 1, wherein the one of the optical filter patterns further comprises a third arc corner, and the third arc corner and the second arc corner are located on two opposite sides of a diagonal line of the one of the optical filter patterns, wherein the curvature radius of the second arc corner is less than the curvature radius of the first arc corner, and a curvature radius of the third arc corner is less than the curvature radius of the first arc corner.

9. The electronic device according to claim 8, wherein the signal line is a scan line.

10. The electronic device according to claim 8, wherein the one of the optical filter patterns further has another diagonal line, and a length of the another diagonal line is different from a length of the diagonal line.

11. The electronic device according to claim 10, wherein the one of the optical filter patterns further comprises an arc corner, and the arc corner and the first arc corner are located on two opposite sides of the another diagonal line, wherein a curvature radius of the arc corner is greater than the curvature radius of the second arc corner and the curvature radius of the third arc corner.

12. The electronic device according to claim 1, wherein the one of the optical filter patterns further comprises a fourth arc corner, and the first arc corner and the fourth arc corner are located on a same side of the one of the optical filter patterns, wherein the curvature radius of the first arc corner is greater than the curvature radius of the second arc corner, and a curvature radius of the fourth arc corner is greater than the curvature radius of the second arc corner.

13. The electronic device according to claim 12, wherein the signal line is a data line.

14. The electronic device according to claim 12, wherein the one of the optical filter patterns further comprises an arc corner, and the arc corner and the second arc corner are located on another side of the one of the optical filter patterns, wherein a curvature radius of the arc corner is less than the curvature radius of the first arc corner.

15. The electronic device according to claim 14, wherein a longest distance between the first arc corner and the fourth arc corner in a direction is less than a longest distance between the second arc corner and the arc corner in the direction.

16. The electronic device according to claim 1, wherein the optical filter patterns comprise a first optical filter pattern, a second optical filter pattern and a third optical filter pattern capable of allowing different colors of light to pass through.

17. The electronic device according to claim 16, wherein the optical filter patterns further comprise another first optical filter pattern adjacent to the first optical filter pattern, and a corner of the first optical filter pattern is connected to a corner of the another first optical filter pattern.

18. The electronic device according to claim 1, wherein a portion of the optical filter patterns are arranged in a first row, another portion of the optical filter patterns are arranged in a second row adjacent to the first row and separated from the portion of the optical filter patterns in the first row.

19. The electronic device according to claim 1, wherein the optical filter patterns in one column are capable of allowing different colors of light to pass through.

20. The electronic device according to claim 1, wherein the optical filter patterns in one column are capable of allowing a same color of light to pass through.
